(19) United States
(12) Patent Application Publication
(10) Pub. No.: US 2022/0025705 A1
(43) Pub. Date: Jan. 27, 2022

(54) LADDER SAFETY DEVICE

(71) Applicant: Jay Mislich, Pontiac, IL (US)

(72) Inventor: Jay Mislich, Pontiac, IL (US)

(21) Appl. No.: 16/934,464

(22) Filed: Jul. 21, 2020

(51) Int. Cl. E06C 7/00; E06C 7/14

(52) U.S. Cl. CPC E06C 7/006; E06C 7/14

(57) ABSTRACT

The present disclosure describes a step ladder safety device.

### TECHNICAL FIELD

The present disclosure is directed generally to ladder use and safety.

### BACKGROUND OF THE INVENTION

Ladders are a mainstay in any type of construction job site whether the user is a union worker or a weekend warrior. Job sites with union workers are highly regulated and projects are under tight time constraints. The Occupational Safety and Health Administration prohibits employees on the job from standing on the ladder top or the upper-most step of a free-standing step ladder (see 29 C.F.R. S.1926.1053(b)(13)). If jobsite inspectors see a ladder user utilizing the top step, the employee's employer can be subject to a substantial fine or the entire job site can be closed. This is drastic, leading to lost days and delayed deliverables. Another scenario is that a ladder user utilizing the top step falls, also leading to a closed job site but with the addition of lost wages and hospital bills. Either option is undesirable and expensive.

Additionally, ladder users are on the ladder for a purpose, usually a task requiring a selection of tools. As such, the necessary tools are often set atop the ladder platform where they can easily fall causing property damage or human injury, or the ladder user repeatedly makes trips up and down the ladder in order to gather essential tools. The more trips up and down a ladder lead to more opportunity for injury.

Therefore, there is a need for an easy and inexpensive tool to not only discourage using the ladder's top step but preventing the use outright.

### SUMMARY OF THE DISCLOSURE

It is against the above background that the present disclosure provides certain advantages and advancements over the prior art.

Although this disclosure is not limited to specific advantages or functionalities, the disclosure provides a step ladder safety device comprising at least five panels in the substantial shape of a hollow, truncated, open-bottom substantially-pyramidal-shaped frustrum comprising four substantially-vertical panels and a top panel, wherein:

each panel comprises four edges cut at various angles; and each panel comprises two surfaces, an inside surface and an outside surface wherein the inside surface of the panel is in contact with the step ladder when the safety device is in place on the step ladder;

the top panel sits atop a platform of a step ladder so that the inside surface of the top panel is in contact with the top of the step ladder platform and the top panel is parallel to the floor on which the step ladder is placed;

the four substantially-vertical panels include a back panel, a front panel, a first side panel and a second side panel, wherein:
a) the back panel comprises a top edge, a bottom edge, a first side edge, and a second side edge; and the back panel is arranged so that the inside surface of the back panel contacts the rear support of the step ladder and also faces toward the front of the stepladder;
b) the front panel comprises a top edge, a bottom edge, a first side edge, and a second side edge, and the front panel is situated so that the inside surface of the front panel contacts the front of the step ladder and faces the inside surface of the back panel;
c) the first side panel comprises a top edge, a bottom edge, a first side edge, and a second side edge;
d) the second side panel comprises a top edge, a bottom edge, a first side edge, and a second side edge;
e) the two side panels are situated on the stepladder opposite of each other so that the inside surfaces of the side panels face each other and contact the sides of the stepladder;
f) the panels are connected so that the back edge of the top panel connects with the top edge of the back panel, the front edge of the top panel connects with the top edge of the front panel, the first side edge of the top panel connects to the top edge of the first side panel, and the second side edge of the top panel connects to the top edge of the second side panel; the back panel is connected along its first side edge to the corresponding first side edge of the first side panel, which is itself connected along its second side edge to the corresponding first side edge of the front panel which is itself connected along its second side edge to the corresponding first side edge of the second side panel, which the second side panel joins at its second side edge with the second side edge of the back panel;

the five-panel body is suitable to be mounted and retained by gravitational force at the apex of a step ladder; and

the front panel is long enough to substantially cover the platform and at least the top rung of a stepladder.

In some aspects of the disclosure, the ladder safety device comprises a walled tray attached to the outer surface of the top panel wherein the walls of the tray are at least about 0.1 inches in height.

In some aspects of the disclosure, the ladder safety device comprises a multiplicity of fasteners which sufficiently secure the safety device to the body of the stepladder.

In some aspects of the disclosure, the ladder safety device comprises a front panel which ranges between about 10 inches (25 cm) and about 17 inches (44 cm) in length and is at least about 11½ inches (29 cm) in width.

In some aspects of the disclosure, the five panels of the ladder safety device are comprised of a flexible material.

In some aspects of the disclosure, the ladder safety device is comprised wherein any of the substantially vertical panels comprise at least one means for containing implements which is attached to the outside surface of the ladder safety device.

In some aspects of the disclosure, the ladder safety device comprises a substantially-vertical back panel comprising an opening in the middle of the panel.

In some aspects of the disclosure, the ladder safety device comprises the walls of the walled tray attached to the outside surface of the top panel are situated to hold either a round-bottom can wherein the diameter of the round-bottom of the can ranges from 6 inches to 7.5 inches, or a square bottom plastic container with an inside volume of about one gallon.

In some aspects of the disclosure, the ladder safety device comprises at least one wall of the walled tray attached to the outside surface of the top panel comprises at least one attached holder apparatus.

In some aspects of the disclosure, the ladder safety device comprises at least one means for containing implements which is attached to the outside surface of the ladder safety device includes distended pouches or holding units.

In some aspects of the disclosure, the ladder safety device comprises at least one means for containing implements which is attached to the outside surface of the ladder safety device is permanently fastened to the outside surface of at least one of the substantially vertical panels.

In some aspects of the disclosure, the ladder safety device comprises at least one means for containing implements which is attached to the outside surface of the ladder safety device is removably fixed to the outside surface of at least one of the substantially vertical panels so as to be interchangeable and allowing the user to decide which options to use and where to place the holding units.

In some aspects of the disclosure, the ladder safety device comprises at least one means for containing implements which is attached to the outside surface of the ladder safety device are open towards the top end of the panel.

In some aspects of the disclosure, the ladder safety device comprises at least one means for containing implements which is attached to the outside surface of the ladder safety device is comprised of at least two pieces where each piece attaches to the safety device panel and then the two holder unit pieces connect to each other.

In some aspects of the disclosure, the ladder safety device comprises at least one wall of the walled tray attached to the outside surface of the top panel comprises an attached holder apparatus.

In some aspects of the disclosure, the ladder safety device comprises at least one wall of the walled tray attached to the outside surface of the top panel comprises an attached holder apparatus and the at least one attached holder apparatus is retractable.

In some aspects of the disclosure, the ladder safety device comprises at least one attached holder apparatus is retractable.

In some aspects of the disclosure, the ladder safety device comprises at least one means for containing implements comprised of at least two pieces where each piece attaches to the safety device panel and then the two holder unit pieces connect to each other through at least one fastening device.

Another embodiment of the disclosure is a ladder safety device, wherein the at least one fastening device is a zipper, a snap, a button, a hook and loop closure, or a tie.

In some aspects of the disclosure, the ladder safety device comprises at least one holder apparatus is selected from a drill holster, hammer loop, caulking gun loop, tape hanger, clip, and hook.

These and other features and advantages of the present invention will be more fully understood from the following detailed description taken together with the accompanying claims. It is noted that the scope of the claims is defined by the recitations therein and not by the specific discussion of features and advantages set forth in the present description.

### BRIEF DESCRIPTION OF THE DRAWINGS

Referring particularly to the drawings for the purpose of illustration only and not to limit the scope of the invention in any way, these illustrations follow:

FIG. 1 is a diagrammatic perspective view of an embodiment of a truncated-pyramidally shaped ladder safety device in accordance with the present disclosure in operative position atop a step ladder.

FIG. 2 is a direct view of the front of an embodiment of the ladder safety device in accordance with the present disclosure.

FIG. 3 is a direct view of the back of an embodiment of the ladder safety device in accordance with the present disclosure.

FIG. 4 is a side plan view of an embodiment of the ladder safety device in accordance with the present disclosure.

FIG. 5 is a diagrammatic perspective view of an embodiment of the disclosed ladder safety device with an exemplary variation of distended pouches and holding units.

FIG. 6 shows a direct view of the front of an embodiment of the disclosed ladder safety device comprising an exemplary variation of distended pouches and holding units.

FIG. 7 shows a direct view of the back of an embodiment of the disclosed ladder safety device with an opening in the back panel.

FIG. 8 shows is a side plan view of an embodiment of the ladder safety device comprising an exemplary variation of distended pouches and holding units.

FIG. 9 shows a diagrammatic perspective view of one embodiment of the disclosed walled tray which is attached to the top side of the top panel of the ladder safety device.

FIG. 10 shows a diagrammatic perspective view of one embodiment of the disclosed walled tray shaped to securely hold a one-gallon paint can and an attached holder apparatus.

FIG. 11A and FIG. 11B represent one embodiment of the disclosed walled tray comprising an attached retractable holder apparatus.

### DESCRIPTION OF PREFERRED EMBODIMENTS

Any discussion of documents, devices, acts, or knowledge in this specification is included to explain the context of the invention, and does not construe an admission that the disclosed innovation is not novel or that it does not represent a significant advancement above the current state of the art. This description is made for the purpose of illustrating the general principles of the invention and is not to be taken in a limiting sense. The scope of the invention is best determined by reference to the appended claims.

Unless otherwise defined, all technical terms used herein have the same meaning as commonly understood by one of ordinary skill in the art to which this disclosure belongs.

The articles “a” and “an” are used herein to refer to one or to more than one (i.e. at least one) of the grammatical object of the article. By way of example, reference to a “material” means one or more materials.

The step ladder safety device of the present disclosure removably fits to the top portion of a step ladder covering the platform and at least the top rung of the step ladder. The safety device can be temporarily fastened in position on the step ladder through a variety of fasteners known in the art, including, but not limited to canvas ties, plastic ties, hook and loop closures, and others.

The step ladder safety device can be made of many different materials including fabric, plastic, or lightweight metal. One embodiment is preferably made from fabric such as from canvas or cotton duck, or from polyurethane coated cloth. An embodiment is constructed so it is held together by processes known in the art, including, but not limited to sewing, riveting, welding, and/or gluing. An embodiment is constructed with the five major surfaces of its main body in the shape of a truncated four-sided pyramid, although the pyramid is not regular, and all its angles are not always equal. The truncated four-sided pyramid is shaped so as the safety device fits with the shape of a step ladder. The step ladder can be any height over about 4 feet. The angles of the safety device can be gradual and may be less sharp than depicted in the drawings, which are rendered showing the device with sharp angles, and extensions full, for purposes of explanation. When the embodiment is constructed from flexible material, the device assumes the substantial geometric configuration of the structure to which it is mounted—the apex of a step ladder.

For ease of description, the step ladder safety device is said to comprise 5 panels; however, the step ladder safety device may be cut from the same piece of material so that it is one joined panel which is then formed to fit over the apex of a step ladder. Additionally, the ladder safety device may be made up of more than 5 panels that are connected in order for the ladder safety device to fit over the apex of a step ladder. In this disclosure, a panel refers to a section of the ladder safety device that is in contact with a portion of the step ladder. For example, the front panel of the ladder safety device makes contact with the front plane of the step ladder; the back panel of the ladder safety device makes contact with the back plane of the step ladder; and the first and second side panels of the ladder safety device make contact with the two side planes of the step ladder; and the top panel of the ladder safety device makes contact with the plane of the platform of the step ladder. For purposes of this disclosure, it does not matter how many pieces of material are used to create a panel as long as the panel contacts the corresponding plane of the step ladder.

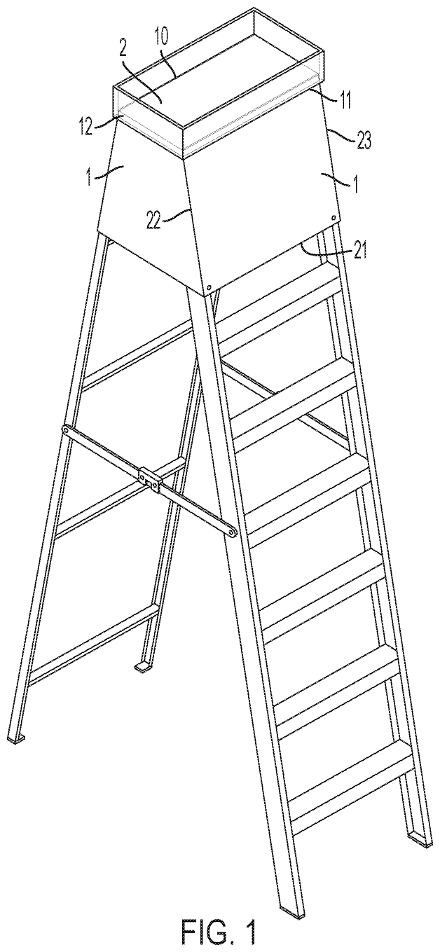

Referring now to the drawings which illustrate some preferred embodiments, FIG. 1 represents a diagram from an angular perspective view of the preferred embodiment of a flexible truncated-pyramidally-shaped ladder safety device in accordance with the present disclosure. The ladder safety device comprises five major panels that define its shape. There are two types of panels, substantially vertical panels 1 which are close to perpendicular to the floor on which the ladder is placed and a top panel 2 that is parallel to the floor on which the ladder is place. Each panel comprises four edges cut at various angles; and each panel comprises two surfaces, an inside surface and an outside surface where the inside surface of the panel is in contact with the step ladder when the safety device is in place on the step ladder.

One of the major panels is a top panel that sits atop the platform of the step ladder so that the inside surface of the top panel is in contact with the top of the step ladder platform. The top panel is parallel to the floor on which the step ladder is placed. The top panel comprises a back edge 10, a front edge 11, and two side edges 12. The back edge 10 is located at the backside of the step ladder, the front edge 11 is located at the front side (or rung side) of the step ladder, and each of the two side edges 12 are on each side of the stepladder.

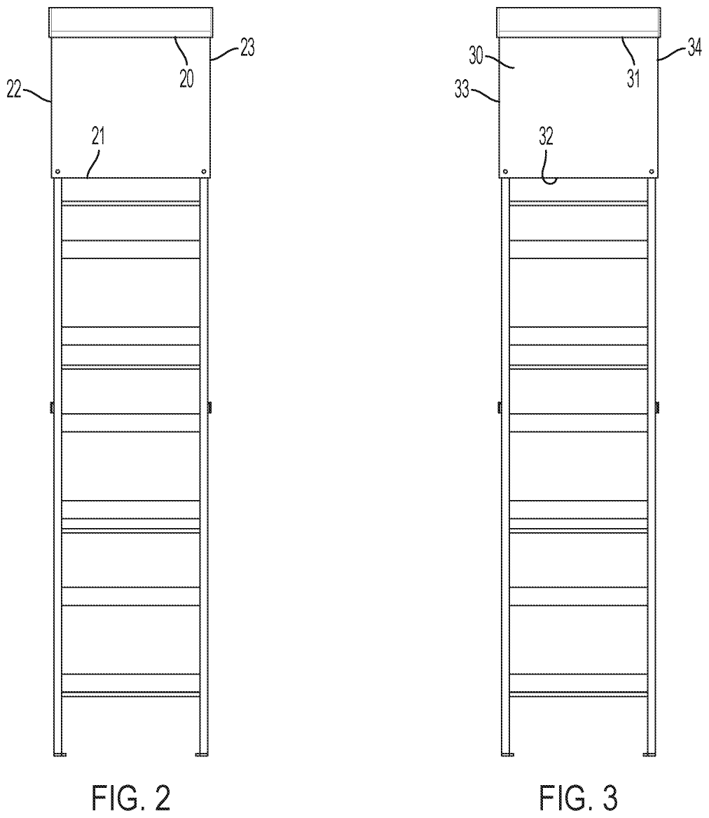

In looking at FIG. 2, another substantially vertical panel is a front panel comprising a top edge, a bottom edge 21, a first side edge 22, and a second side edge 23 as well as an inside surface and outside surface. The front panel is situated so that the inside surface of the front panel is in contact with the front of the step ladder and the inside surface of the front panel also faces the inside surface of the back panel.

The front panel is long enough to substantially cover the platform and at the top rung of a step ladder. In some embodiments, the front panel is between 10 inches (25 cm) and 17 inches (44 cm) in length and is at least about 11½ inches (29 cm) in width, as these are the guidelines established by OSHA 1926.1053(a)(3)(i) and OSHA 1926.1053(a)(4)(ii), respectfully.

FIG. 3 shows a representation of an additional major panel of the safety device, the back panel 30. This back panel comprises a top edge 31, a bottom edge 32, a first back side edge 33, and a second back side edge 34 as well as an inside surface and an outside surface. The back panel is arranged so that the inside surface of the back panel contacts the rear support of the step ladder and also faces toward the front of the stepladder. In some embodiments, the back panel is a full panel completely covering the back of the step ladder.

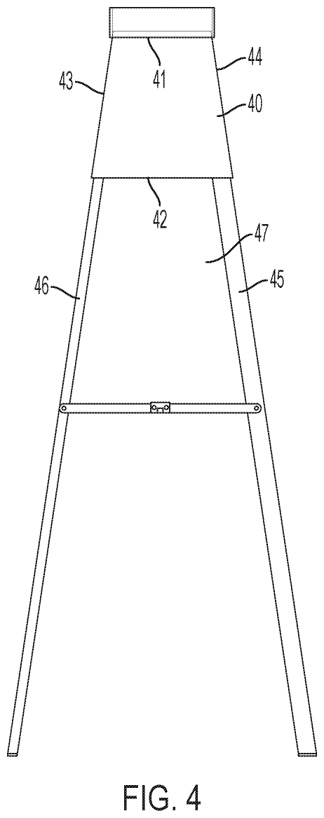

The remaining substantially vertical panels are a first side panel and a second side panel and the bases of each mirror one another. FIG. 4 shows one of the side panels 40. Each side panel comprises a top edge 41, bottom edge 42, first side edge 43 and second side edge 44 as well as an inside surface and an outside surface. The two side panels are situated on the stepladder opposite of each other so that the inside surfaces of the side panels contact the sides of the stepladder and the inside surfaces of the side panels face each other.

The five panels are connected so that the back edge of the top panel 10 connects with the top edge of the back panel 31, the front edge of the top panel 11 connects with the top edge of the front panel 20, the first side edge of the top panel 12 connects to the top edge of the first side panel 41, and the second side edge of the top panel (not shown) connects to the top edge of the second side panel. Additionally, the back panel is connected along its first side edge 33 to the corresponding first side edge of the first side panel 43, which is itself connected along its second side edge 44 to the corresponding first side edge of the front panel 22, and the second side edge 23 of the front panel is connected to the corresponding first side edge of the second side panel, and the second side panel joins at its second side edge with the second side edge of the back panel 34.

When mounted to a step ladder, the front panel fits over and against uppermost regions of the rung, step, or front portion of the step ladder. The back panel correspondingly fits over and against the uppermost regions of the back portion of the step ladder. Both side panels bridge the trapezoidal-shaped area 47 between a front rail 45 and back rail 46 of the step ladder, in other words, the side panels span between the front and rear sections of the step ladder at its apex. The inside surface of the top panel fits on, over, and against the platform of the step ladder.

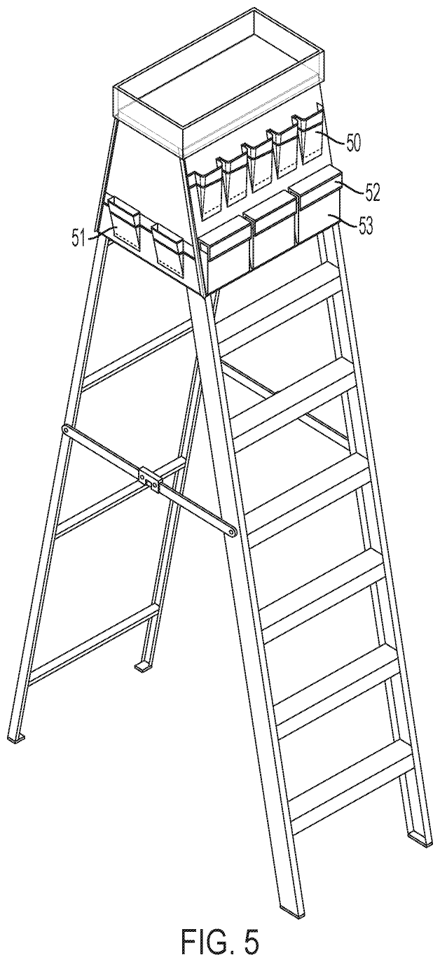

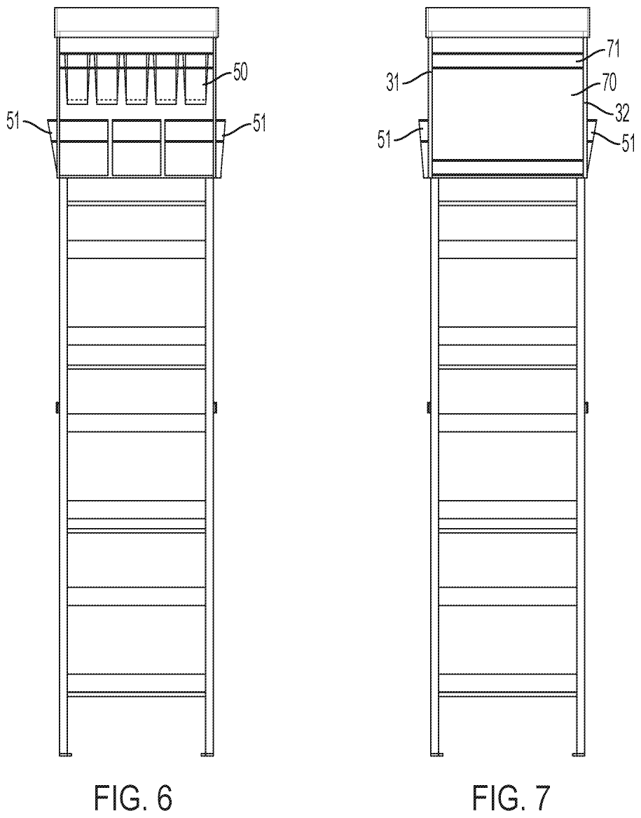

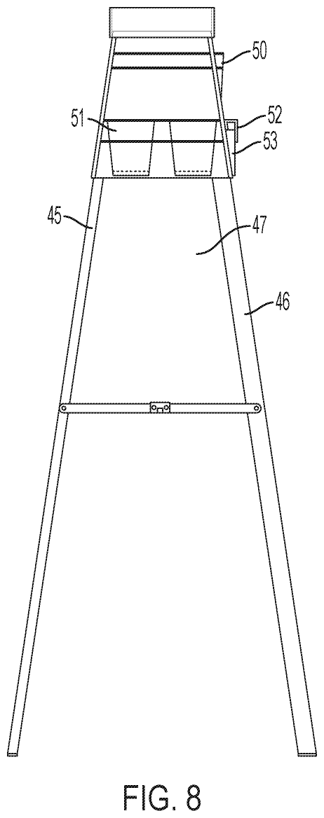

As seen in FIG. 5, FIG. 6, FIG. 7, and FIG. 8, the safety device optionally comprises one or more distended pouches and various units (holding units), receptacles, pockets, hooks, hangers, clips, and the like located on the outside surfaces of the back, front 50, and/or side panels 51. In some embodiments, the one or more holding units are arranged in various combinations and sizes. In some embodiments, the holding units are similar in size. The sizing of the holding units is nominal and can range in size of about 1×1 inches (width×height) to as large as covering the entire panel. In some embodiments, the holding units comprise a range in depth from greater than 0 inches to as much as about 12 inches deep 50. This depth can be gradual or can be absolute. In some embodiments, the various holding units are permanently fixed to the safety device through means known in the art. In other embodiments, the various holding units are removably fixed as to be interchangeable allowing the user to decide which options to use and where to place the holding units. In some embodiments, the holding units are open towards the top end of the panel 50. In some embodiments, the holding units are comprised of at least two pieces, a top piece 52 and a bottom piece 53, where each piece attaches to the safety device panel and then the two holder unit pieces connect to each other. In some embodiments, the holding units have a fastening device on them, such as a zipper, at least one snap, at least one button, hook and loop closure, ties, or other devices known in the art which keeps the two holder unit pieces connected.

FIG. 7 depicts how some embodiments comprise a substantially vertical back panel which is not a full panel; rather the back panel comprises at least one opening 70. The at least one opening 70 in the back panel can be of various size. A back panel comprising at least one opening allows for the back panel to comprise fasteners for securing to the step ladder, while also allowing for the use of certain accessories attached to the step ladder which are beneficial to the ladder user. Additionally, the open back panel 70 allows for a reduction in weight of the safety apparatus. In some embodiments where the back panel comprises an opening 70, there are one or more supports 71 running horizontally across the opening from the first back side edge 31 to the second back side edge 32. These supports can be made of the same material that the back panel is made of or can be made of a different material.

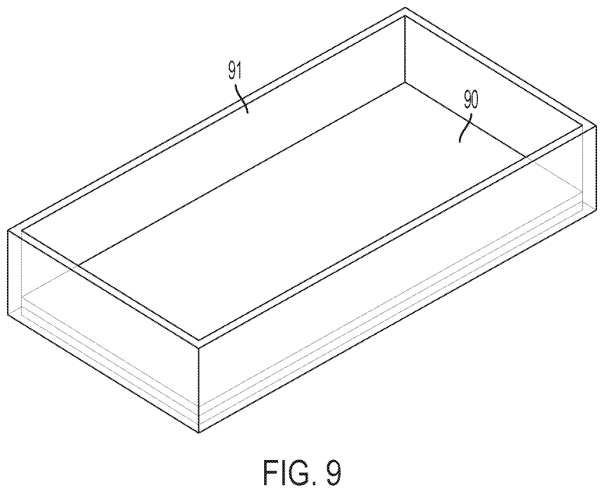

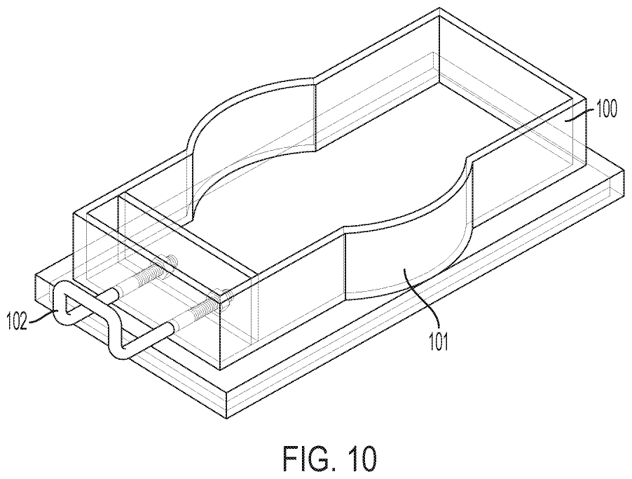

As shown in FIG. 9, in some embodiments of the disclosure, the top panel of the ladder safety device comprises a platform 90 with a top and a bottom. The bottom of the platform is attached to the top side of the top panel of the ladder safety device. In some embodiments, there are raised peripheral walls perpendicularly attached to and extending from the top side of the platform 91, creating a walled tray. In some embodiments, the raised peripheral walls are at least about 0.1 inches in height and can range up to about 12 inches in height. In some embodiments, the walls of the walled tray are foldable. As seen in FIG. 10, certain embodiments of the disclosure comprise walls of the walled tray 100 that are not straight, rather the walls running along the front and back of the platform are shaped 101 (either curved or angled, for example) as to securely hold a one-gallon paint can. In such embodiments where the walls are shaped to securely hold a round bottom container with a diameter ranging from about 6 inches to about 7.5 inches, such as a round bottom paint canister. In some embodiments where the walls are shaped to securely hold a one-gallon paint container, the container is a square bottom plastic container such as described in U.S. Pat. Nos. 6,896,156 and 7,040,509.

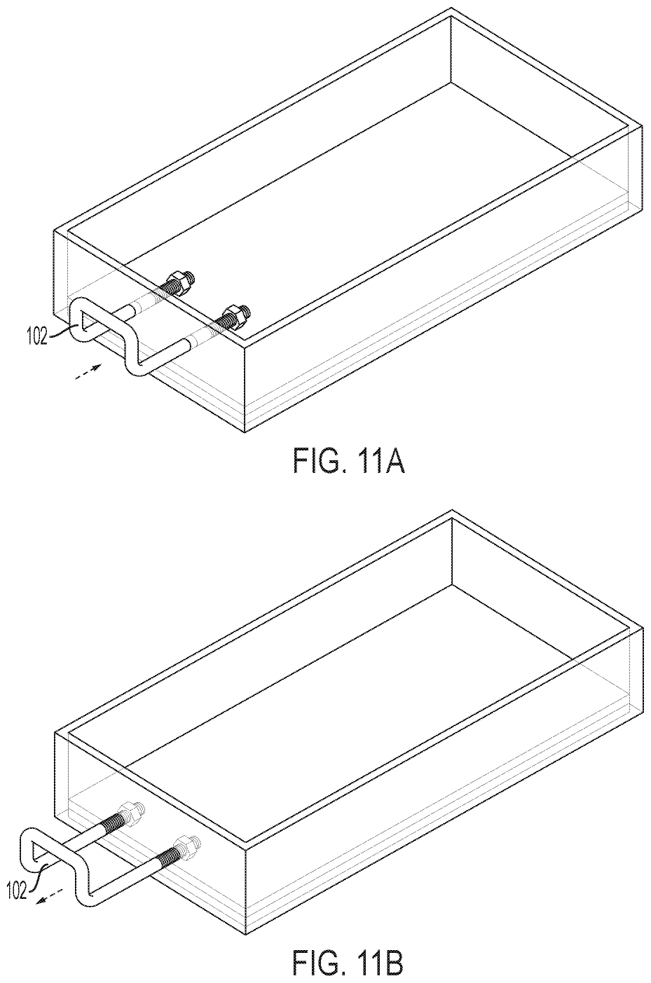

In some embodiments, the walled tray comprises an attached holder apparatus 102 on at least one of its walls. In some embodiments, at least one of the walls comprises more than one attached holder apparatus. In some embodiments, the attached holder apparatus 102 is attached to the walled tray in a fixed position. However, as depicted in FIGS. 11A and 11B, in some embodiments, the one or more attached holder apparatuses 102 are retractable. Examples of an attached holder apparatus include, but are not limited to, a drill holster, hammer loop, caulking gun loop, tape hanger, clip, hook, and others known in the art.

The current disclosure describes and shows herein what is considered to be the most practical and preferred embodiments. However, it is recognized that departures may be made therefrom within the scope of the disclosure and that obvious modifications will occur to a person ordinarily skilled in the art. It is clear that there will be variations in the shape of the top panel, and substantially vertical panels including the front panel, back panel, side panels, means of attachment, and the like within the scope of the invention. Those skilled in the art, to which this invention pertains, will clearly understand those variations and the claimed scope of the invention.

What is claimed is:

1) A step ladder safety device having a body comprising at least five panels in the substantial shape of a hollow, truncated, open-bottom substantially-pyramidally-shaped frustrum comprising four substantially-vertical panels and a top panel, wherein:
each panel comprises four edges cut at various angles; and each panel comprises two surfaces, an inside surface and an outside surface wherein the inside surface of the panel is in contact with the step ladder when the safety device is in place on the step ladder;
the top panel sits atop a platform of a step ladder so that the inside surface of the top panel is in contact with the top of the step ladder platform and the top panel is parallel to the floor on which the step ladder is placed;
the four substantially-vertical panels include a back panel, a front panel, a first side panel and a second side panel, wherein:
a) the back panel comprises a top edge, a bottom edge, a first side edge, and a second side edge; and the back panel is arranged so that the inside surface of the back panel contacts the rear support of the step ladder and also faces toward the front of the stepladder;
b) the front panel comprises a top edge, a bottom edge, a first side edge, and a second side edge, and the front panel is situated so that the inside surface of the front panel contacts the front of the step ladder and faces the inside surface of the back panel;
c) the first side panel comprises a top edge, a bottom edge, a first side edge, and a second side edge;
d) the second side panel comprises a top edge, a bottom edge, a first side edge, and a second side edge;
e) the two side panels are situated on the stepladder opposite of each other so that the inside surfaces of the side panels face each other and contact the sides of the stepladder;
f) the panels are connected so that the back edge of the top panel connects with the top edge of the back panel, the front edge of the top panel connects with the top edge of the front panel, the first side edge of the top panel connects to the top edge of the first side panel, and the second side edge of the top panel connects to the top edge of the second side panel; the back panel is connected along its first side edge to the corresponding first side edge of the first side panel, which is itself connected along its second side edge to the corresponding first side edge of the front panel which is itself connected along its second side edge to the corresponding first side edge of the second side panel, which the second side panel joins at its second side edge with the second side edge of the back panel;
the five-panel body is suitable to be mounted and retained by gravitational force at the apex of a step ladder; and
the front panel is long enough to substantially cover the platform and at least the top rung of a stepladder.

2) The ladder safety device of claim 1, further comprising a walled tray attached to the outer surface of the top panel wherein the walls of the tray are at least about 0.1 inches in height.

3) The ladder safety device of claim 1, further comprising a multiplicity of fasteners which sufficiently secure the safety device to the body of the stepladder.

4) The ladder safety device of claim 1, further wherein the front panel ranges between about 10 inches (25 cm) and about 17 inches (44 cm) in length and is at least about 11½ inches (29 cm) in width.

5) The ladder safety device of claim 1, wherein the five panels are comprised of a flexible material.

6) The ladder safety device of claim 1, wherein any of the substantially vertical panels comprise at least one means for containing implements which is attached to the outside surface of the ladder safety device.

7) The ladder safety device of claim 1, wherein the substantially-vertical back panel comprises an opening in the middle of the panel.

8) The ladder safety device of claim 2, further wherein the walls of the walled tray attached to the outside surface of the top panel are situated to hold either a round-bottom can wherein the diameter of the round-bottom of the can ranges from 6 inches to 7.5 inches, or a square bottom plastic container with an inside volume of about one gallon.

9) The ladder safety device of claim 2, wherein at least one wall of the walled tray attached to the outside surface of the top panel comprises at least one attached holder apparatus.

10) The ladder safety device of claim 6, wherein the at least one means for containing implements which is attached to the outside surface of the ladder safety device includes distended pouches or holding units.

11) The ladder safety device of claim 6, wherein the at least one means for containing implements which is attached to the outside surface of the ladder safety device is permanently fastened to the outside surface of at least one of the substantially vertical panels.

12) The ladder safety device of claim 6, wherein the at least one means for containing implements which is attached to the outside surface of the ladder safety device is removably fixed to the outside surface of at least one of the substantially vertical panels so as to be interchangeable and allowing the user to decide which options to use and where to place the holding units.

13) The ladder safety device of claim 6, wherein the at least one means for containing implements which is attached to the outside surface of the ladder safety device are open towards the top end of the panel.

14) The ladder safety device of claim 6, wherein the at least one means for containing implements which is attached to the outside surface of the ladder safety device is comprised of at least two pieces where each piece attaches to the safety device panel and then the two holder unit pieces connect to each other.

15) The ladder safety device of claim 8, wherein at least one wall of the walled tray attached to the outside surface of the top panel comprises an attached holder apparatus.

16) The ladder safety device of claim 8, wherein at least one wall of the walled tray attached to the outside surface of the top panel comprises an attached holder apparatus and the at least one attached holder apparatus is retractable.

17) The ladder safety device of claim 9, wherein the at least one attached holder apparatus is retractable.

18) The ladder safety device of claim 14, further wherein the at least one means for containing implements comprised of at least two pieces where each piece attaches to the safety device panel and then the two holder unit pieces connect to each other through at least one fastening device.

19) The ladder safety device of claim 15, wherein the at least one fastening device is a zipper, a snap, a button, a hook and loop closure, or a tie.

20) The ladder safety device of claim 16, wherein the at least one holder apparatus is selected from a drill holster, hammer loop, caulking gun loop, tape hanger, clip, and hook.
